(19) United States
(12) Patent Application Publication
(10) Pub. No.: US 2005/0129448 A1
(43) Pub. Date: Jun. 16, 2005

(54) Printing media feeder of printing apparatus

(75) Inventor: Ho-il Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/865,871

(22) Filed: Jun. 14, 2004

(30) Foreign Application Priority Data
Dec. 16, 2003 (KR) 2003-92063

(51) Int. Cl. B41J 11/58

(52) U.S. Cl. 400/624

(57) ABSTRACT

A printing media feeder of a printing apparatus, having: a printing media feeder frame with a predetermined space and a front opening and side openings communicating with the space; a feeding cassette movably mounted in the space of the printing media feeder frame to enter in and come out of the space through the front opening; and a pickup unit mounted on a side of the printing media feeder frame and integrally having a cassette guide to guide movement of the feeding cassette. The pickup unit includes a body frame and the cassette guide may be formed as a separate member to be mounted on the body frame, or may be integrally formed with the body frame.

### CROSS-REFERENCE TO RELATED APPLICATIONS

This application claims benefit of Korean Patent Application No. 2003-92063, filed on Dec. 16, 2003 in the Korean Intellectual Property Office, the disclosure of which is incorporated herein by reference.

### BACKGROUND OF THE INVENTION

1. Field of the Invention

The present invention relates to a printing apparatus, and more particularly, to a printing media feeder of a printing apparatus, which supplies printing media to an image forming unit of the printing apparatus.

2. Description of the Related Art

As printing apparatuses of large scale and high speed develop, convenience in maintenance of the printing media feeder has emerged as an important issue. Therefore, the unit constituting the printing media feeder has recently been made as a module, so that maintenance and assembling processes can be carried out conveniently.

FIG. 1 is an exploded perspective view of a printing media feeder of a conventional printing apparatus. In FIG. 1, the reference numeral 10 represents a printing media feeder frame, and the references numerals 20, 30, and 40 represent a pickup unit, a cassette, and a cassette guide, respectively.

The printing media feeder frame 10 has a space which is open at the front thereof, and both lateral sides thereof. The pickup unit 20 is mounted on one side of the printing media feeder frame 10 by a suitable fastener, and the cassette 30 is installed on the printing media feeder frame 10 to move into and out of the front of the frame 10. The cassette guide 40 is fastened to one of the lateral sides of the printing media feeder frame 10 by a fastener, to guide movement of the cassette 30.

In the foregoing conventional printing media feeder of the printing apparatus, a separation and disassembling process is performed in the following way: first, the cassette 30 is separated from the printing media feeder frame 10; then, the cassette guide 40 is separated from the frame 10; and then, the pickup unit 20 is separated from the frame 10. Assembly is performed in a reverse order.

In the above-described conventional printing media feeder of the printing apparatus, since the pickup unit 20 and the cassette guide 40 are provided as separate elements, the elements are assembled and disassembled, requiring respective assembling and disassembling processes, and thus, assembly efficiency is reduced.

Furthermore, since the pickup unit 20 and the cassette guide 40 are separately assembled to the frame 10, the respective assembling positions may vary, whereby feeding malfunctions (jam and skew) might be generated.

### SUMMARY OF THE INVENTION

The present invention has been developed to solve the above and/or other drawbacks and problems associated with the conventional printing media feeder. An aspect of the present invention is to provide a printing media feeder of a printing apparatus, capable of improving assembly efficiency and preventing disagreement of assembling position by integrally forming the cassette guide on the pickup unit.

The foregoing and/or other aspects and advantages are realized by providing a printing media feeder of a printing apparatus, which comprises: a printing media feeder frame having a predetermined space, and a front opening and side openings communicating with the space; a feeding cassette movably mounted in the space of the printing media feeder frame, to enter in and come out of the space through the front opening; and a pickup unit mounted on a side of the printing media feeder frame, and integrally having a cassette guide to guide movement of the feeding cassette.

According to one aspect, the pickup unit includes a body frame, and the cassette guide is mounted on the body frame. According to another aspect, the cassette guide is integrally formed with the body frame.

According to one aspect of the present invention, the cassette guide has a flattened ‘U’ shaped cross section and an entrance part that is widened with respect to a main part of the cassette guide, to facilitate mounting of the feeding cassette.

According to one aspect, the cassette guide has at least one roller to facilitate movement of the feeding cassette, and a protruding hook to prevent the feeding cassette from being arbitrarily detached. According to one aspect, the roller and the protruding hook are installed on lower and upper sides of the cassette guide, respectively.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is an exploded perspective view of a conventional printing media feeder of a printing apparatus;

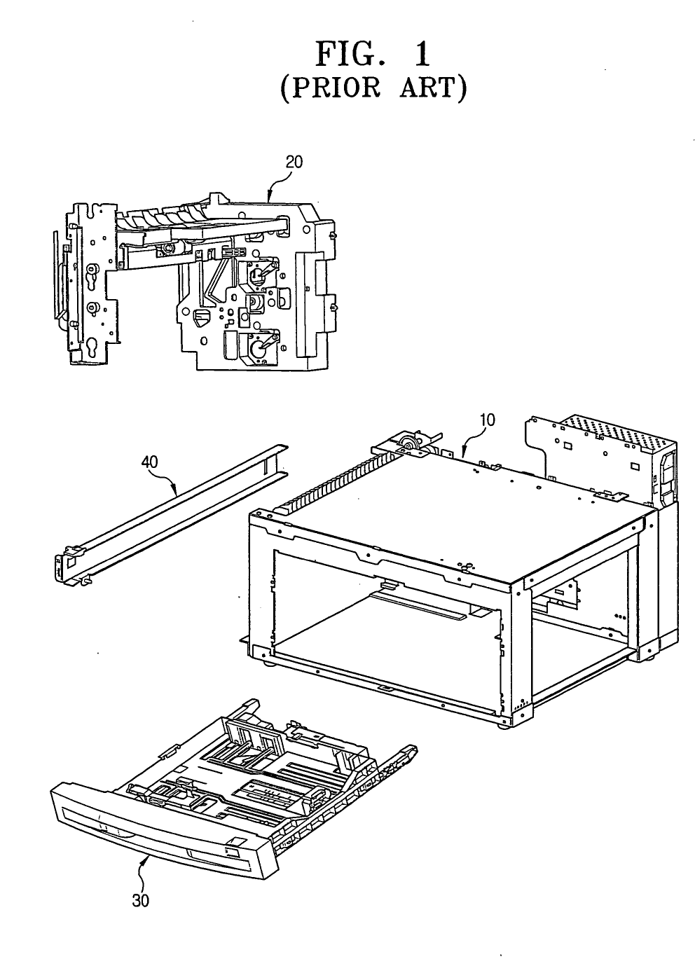

FIG. 2 is an exploded perspective view of a printing media feeder of a printing apparatus according to an embodiment of the invention;

FIG. 3 is a perspective view of a pickup unit of FIG. 2; and

FIG. 4 is a perspective view of a pickup unit of a printing media feeder according to a second embodiment of the invention.

### DETAILED DESCRIPTION

Reference will now be made in detail to the embodiments of the present invention, examples of which are illustrated in the accompanying drawings, wherein like reference numerals refer to the like elements throughout. The embodiments are described below to explain the present invention by referring to the figures.

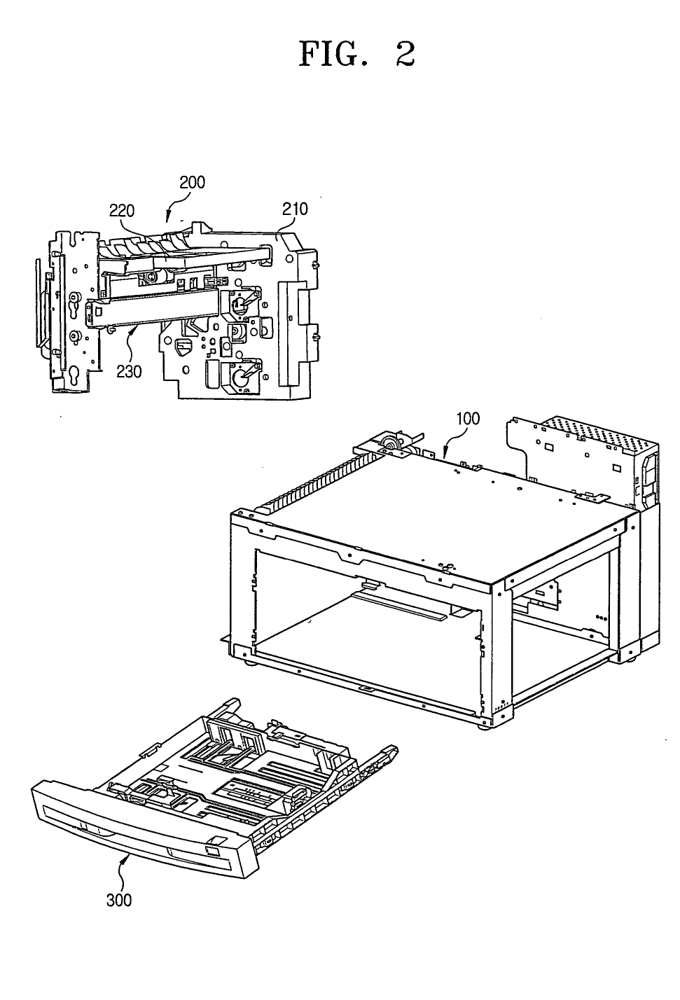

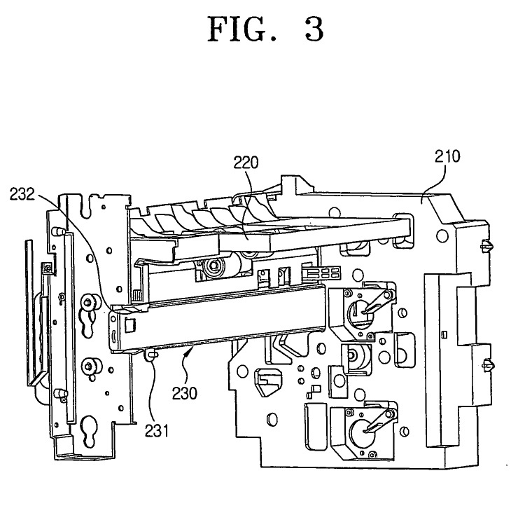

As is shown in FIGS. 2 and 3, the printing media feeder frame 100 has a space whose front and both lateral sides are open. A pickup unit 200 is mounted on a side of the printing media feeder frame 100, and a feeding cassette 300 is mounted in the space of the printing media feeder frame 100, to move in and out from a front of the printing media feeder frame 100.

The pickup unit 200 is designed to pick up a printing medium (not shown), such as a paper sheet, stored in the feeding cassette 300. The pickup unit 200 comprises a body frame 210, a feeding roller assembly 220, and a cassette guide 230.

The cassette guide 230 is integrally formed on the pickup unit 200 according to one embodiment of the invention. Therefore, if the pickup unit 200 is mounted on the printing media feeder frame 100, the cassette guide 230, integrally formed on the pickup unit 200, is situated in a predetermined position of the printing media feeder frame 100, to guide movement of the feeding cassette 300. Thus, the process of mounting the pickup unit 200 on the printing media feeder frame and subsequently assembling the cassette guide 230, as was done in the conventional art, can be omitted.

According to one embodiment, the cassette guide 230 is not connected to the printing media feeder frame 100.

According to one embodiment, the cassette guide 230 has a cross-section that is substantially of a flattened-U shape. According to one embodiment, the cassette guide 230 is mounted on the pickup unit 200 after being formed as a separate member.

According to one embodiment, the cassette guide 230 is configured such that an entrance part of the cassette guide 230 is widened relative to a main part of the cassette guide 230, to facilitate mounting of the feeding cassette 300. A roller 231 is provided on a lower side of the cassette guide 230, to facilitate movement of the feeding cassette 300. A protruding hook 232 is provided on an upper side, of the cassette guide 230, to prevent the feeding cassette 300 from being arbitrarily detached.

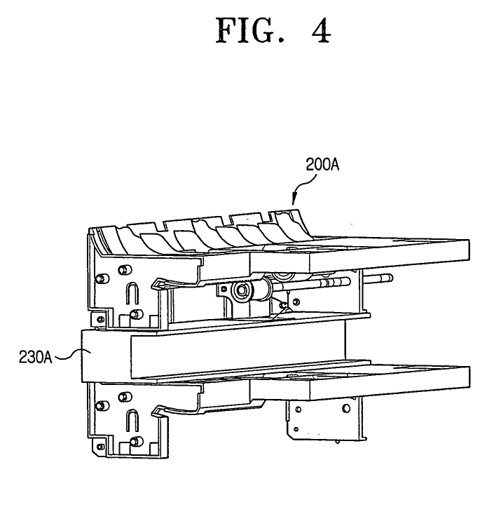

FIG. 4 is a perspective view of a pickup unit 200A, which is a crucial part of a printing media feeder according to a second embodiment of the invention.

As is shown in FIG. 4, in the printing media feeder of the printing apparatus according to the second embodiment of the invention, a frame of the pickup unit 200A and the cassette guide 230A are integrally formed by an injection-molding process. Other constructions are the same as the foregoing embodiment of the present invention.

The following is an assembly process of the printing media feeder of the printing apparatus having the foregoing construction. First, the pickup unit 200 is mounted on the side of the printing media feeder frame 100. When the pickup unit 200 is mounted on the side of the printing media feeder frame 100, the cassette guide 230, which according to one embodiment, is integrally formed on the pickup unit 200, is situated on a predetermined position of the printing media feeder frame 100. Thereafter, the feeding cassette 300 is mounted on the printing media feeder frame 100 so that it is guided by the cassette guide 230.

If the printing media feeder is disassembled, e.g., for maintenance, the feeding cassette 300 is first separated from the printing media feeder frame 100, and then the pickup unit 200 is separated from the printing media feeder frame 100, so that maintenance may be carried out.

As previously noted, during assembly and disassembly of the conventional printing media feeder, e.g., for maintenance, the pickup unit and the separately provided cassette guide are sequentially assembled and disassembled to and from the frame. But according to embodiments of the present invention, since the pickup unit and the cassette guide are integrally formed, only the pickup unit must be attached and detached to and from the frame for maintenance.

Furthermore, disagreement in assembling position among the pickup unit 200, the cassette guide 230, and the feeding cassette 300 can be prevented.

According to one embodiment, since the cassette guide 230 is integrally formed on the pickup unit, assembly efficiency can be improved, and maintenance efficiency can be improved even more, since maintenance requires both disassembly and reassembly.

Furthermore, since the cassette guide can be accurately situated on the relevant position of the printing media feeder frame, feeding malfunctions, such as paper skew, a paper jams that may be generated due to disagreement in assembling position of the cassette guide, can be prevented. Thus, a high degree of operability of the printing media feeder can be achieved.

Thus, in the printing media feeder of the printing apparatus according to an embodiment of the present invention, since the cassette guide is integrally formed on the pickup unit, a number of the elements is reduced in comparison with the conventional apparatus, therefore, not only assembly efficiency can be improved but also the disagreement of the assembling position can be prevented.

Although a few embodiments of the present invention have been shown and described, it would be appreciated by those skilled in the art that changes may be made in this embodiment without departing from the principles and spirit of the invention, the scope of which is defined in the claims and their equivalents.

1. A printing media feeder of a printing apparatus, comprising:
a printing media feeder frame having a predetermined space, and a front opening and side openings communicating with the space;
a feeding cassette movably mounted in the space of the printing media feeder, to enter in and come out of the space through the front opening; and
a pickup unit mounted on a side of the printing media feeder frame, and integrally having a cassette guide to guide movement of the feeding cassette.

2. The printing media feeder as claimed in claim 1, wherein the pickup unit comprises a body frame, and the cassette guide is mounted on the body frame.

3. The printing media feeder as claimed in claim 1, wherein:
the cassette guide has a cross section of a flattened-U shape; and
an entrance part of the cassette guide is widened with respect to a main part of the cassette guide, to facilitate mounting of the feeding cassette.

4. The printing media feeder as claimed in claim 3, wherein the cassette guide comprises:
at least one roller for to facilitate movement of the feeding cassette; and
a protruding hook to prevent the feeding cassette from being arbitrarily detached from the cassette guide.

5. The printing media feeder as claimed in claim 4, wherein the roller and the protruding hook are installed on a lower and an upper side of the cassette guide, respectively.

6. The printing media feeder as claimed in claim 1, wherein:
the pickup unit comprises a body frame; and
the cassette guide is integrally formed with the body frame.

7. A printing media feeder of a printing apparatus, comprising:
a printing media feeder frame defining a space and having first and second openings communicating with the space;
a feeding cassette to hold media, movably communicating with the space via the first opening;
a pickup unit connected with the printing media feeder frame and communicating with the space via the second opening; and
a cassette guide connected with the pickup unit and guiding movement of the feeding cassette.

8. The printing media feeder according to claim 7, wherein the cassette guide is not connected to the printing media feeder frame.

9. The printing media feeder according to claim 7, wherein the cassette guide is integrally formed with the pickup unit.

10. The printing media feeder according to claim 7, wherein the pickup comprises:
a body frame; and
a feeding roller assembly, to feed the media.

11. The printing media feeder according to claim 10, wherein the cassette guide is integrally formed with the body frame.

12. The printing media feeder according to claim 11, wherein the cassette guide and the body frame are integrally formed by an injection molding process.

13. The printing media feeder according to claim 7, wherein an entrance part of the cassette guide is widened compared with a main part of the cassette guide, to facilitate mounting of the feeding cassette.

14. The printing media feeder according to claim 7, wherein the cassette guide has a flattened-U shaped cross section.

15. The printing media feeder according to claim 7, wherein the cassette guide comprises a roller to facilitate movement of the feeding cassette.

16. The printing media feeder according to claim 7, wherein the cassette guide comprises a protruding hook, to inhibit detachment of the feeding cassette.

17. The printing media feeder according to claim 16, wherein:
the cassette guide further comprises a roller disposed at a first side of the cassette guide, to facilitate movement of the feeding cassette; and
the protruding hook is disposed at a second side of the cassette guide.

18. A method of assembling a printing media feeder of a printing apparatus, the method comprising:
connecting a pickup unit with a printing media feeder frame at a first opening of the printing media feeder frame, the printing media feeder frame defining a space and having the first opening and a second opening, each of the openings communicating with the space; and
connecting a feeding cassette with a cassette guide of the pickup unit, to movably communicate with the space via the second opening of the printing media feeder frame.

19. The method according to claim 18, wherein the feeding cassette is integrally formed with the pickup unit.
